(19) United States
(12) Patent Application Publication
(10) Pub. No.: US 2005/0141783 A1
(43) Pub. Date: Jun. 30, 2005

(54) Method for detecting resolution and device for the same

(75) Inventors: Chi-Min Chen, Erlin Township (TW); Chih-Ming Tsai, Wugu Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ICP Electronics Inc.

(21) Appl. No.: 10/996,584

(22) Filed: Nov. 23, 2004

(30) Foreign Application Priority Data
Dec. 26, 2003 (TW) 92137053

(51) Int. Cl. G06K 9/36

(52) U.S. Cl. 382/286

(57) ABSTRACT

The invention discloses a method for detecting resolution and a device for the same. Resolution data entries corresponding to a display device are classified into a plurality of first and second counting groups according to first and second timing counts respectively. Image signals from a video source are detected, acquiring a first counting group and a second counting group according to the resolution data entries. When the only resolution data entry corresponding to the image signals is included in the first counting group, the image signals corresponding to the resolution data entry is displayed. When a first resolution data entry and at least one second resolution data entry are included in the first counting group and only the first resolution data entry is included in the second counting group, the image signals corresponding to the first resolution data entry is displayed.

### BACKGROUND

The present invention relates to image detection, and in particular to a method and device for detecting resolution.

A keyboard/Video/Mouse (KVM) management system enables system inspection and recovery for remote computer devices through the network, such as the local area network (LAN) or the wide area network (WAN). Additionally, the KVM system also provides the described services through the Internet, referring to KVM access over Internet Protocol (IP), supported in a console mode or graphic user interface (GUI).

Video images are transferred from remote computer devices to local display devices using a KVM system. Image resolution of a display device is changed, however, resulting in incorrect resolution determination and unstable image signals when clocks thereof skew. Thus, a rapid resolution detection method is desirable, overcoming the described problems.

### SUMMARY

Accordingly, an object of the present invention is to provide a method for detecting resolution, classifying resolution data entries of a display device into a plurality of counting groups for accurate resolution detection.

Another object of the invention is to provide a method for detecting resolution, calculating the time difference while resolution variation according to polarities corresponding to resolution data entries of a display device for rapid resolution detection.

According to the object described, embodiments of the present invention provide a method for detecting resolution. A display resolution table comprising a plurality of resolution data entries corresponding to a display device is established, each resolution data entry corresponding to a first timing count and a second timing count respectively.

The resolution data entries are classified into a plurality of first counting groups according to each first timing count, each first counting group comprising at least one resolution data entry and one first timing count and one second timing count corresponding to the resolution data entry. Next, the resolution data entries are classified into a plurality of second counting groups according to each second timing count, each second counting group comprising at least one resolution data entry and one first timing count and one second timing count corresponding to the resolution data entry. The resolution data entries stored in a first counting group are stored in different second counting groups respectively.

Next, image signals from a video source are detected, acquiring a first counting group and a second counting group respectively corresponding to the image signals according to the resolution data entries stored in the display resolution table. The image signals corresponding to a resolution data entry existing in the first and second counting groups simultaneously are displayed. Finally, polarities corresponding to the resolution data entries are identified for waveform change.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A and 1B are schematic diagrams showing resolution data entries corresponding to a display device according to an embodiment of the invention, in which the resolution data entries are classified into a plurality of first and second counting groups respectively;

FIG. 2 is a schematic diagram of waveform according to the resolution data entries with different polarities according to an embodiment of the invention;

FIG. 3 is a flowchart of the method for resolution detection of an embodiment of the invention; and

FIG. 4 is a schematic diagram of the architecture of the device for resolution detection of an embodiment of the invention.

### DETAILED DESCRIPTION

The present invention discloses a method and device for detecting resolution.

Embodiments of the invention detect image resolution by determining horizontal and vertical synchronization signals based on Video Graphics Array (VGA) of Video Electronics Standards Association (VESA) standards complying with Monitor Timing Specifications.

In the embodiment of the invention, a used system frequency of a detection device is 81 MHz, supporting the highest image resolution and a vertical scanning frequency of 1600×1200@60.

Resolution data entries used in the embodiment of the invention is described in the following: 640×400@70, 640×480@60, 640×480@72, 640×480@75, 640×480@85, 800×600@56, 800×600@60, 800×600@72, 800×600@75, 800×600@85, 1024×768@60, 1024×768@70, 1024×768@75, 1024×768@85, 1152×864@75, 1280×960@60, 1280×960@85, 1280×1024@60, 1280×1024@75, 1280×1024@85, 1600×1200@60.

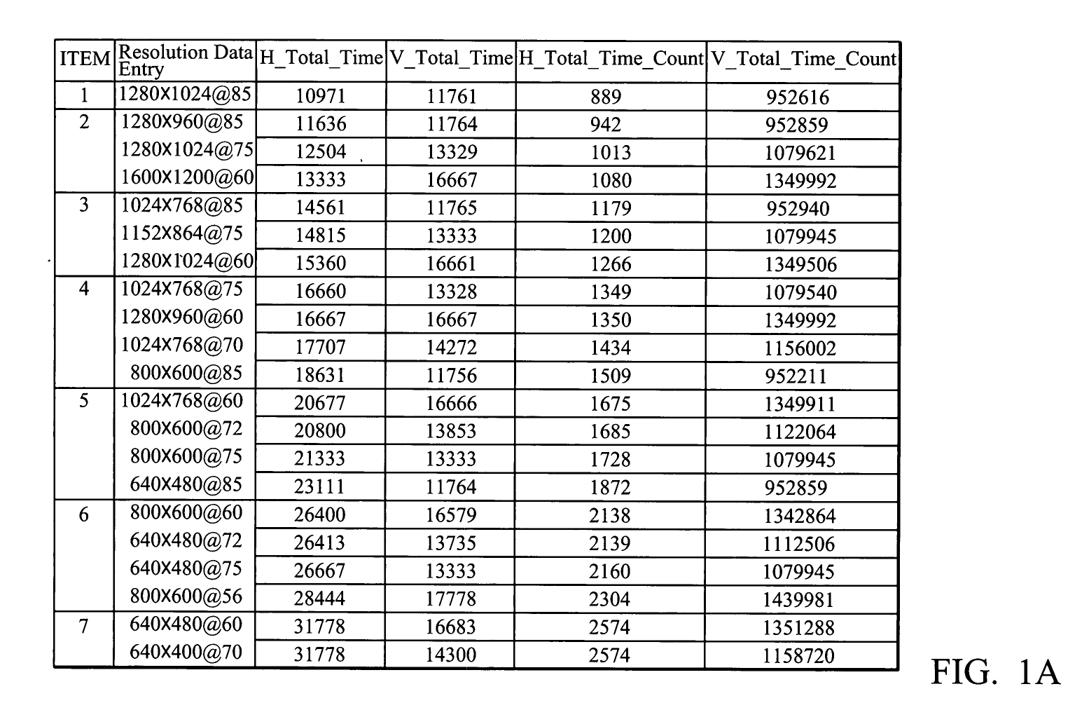

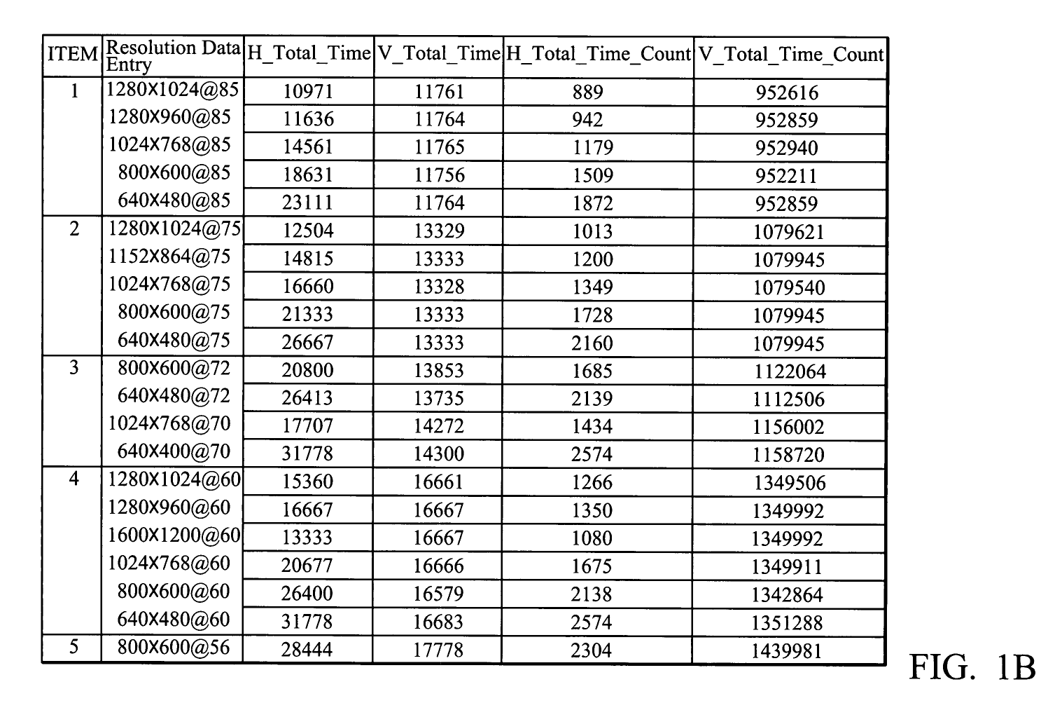

FIGS. 1A and 1B are schematic diagrams showing resolution data entries corresponding to a display device according to an embodiment of the invention, in which the resolution data entries are classified into a plurality of first and second counting groups respectively.

A counter calculates horizontal scanning time counts (H_Total_Time_Count) and vertical scanning time counts (V_Total_Time_Count) according to horizontal scanning times (H_Total_Time) and vertical scanning times (V_Total_Time) corresponding to VESA standards, within a system frequency, for example, 81 MHz, and a clock period. Horizontal scanning time, for example, is 31778 ns, a clock period is 12.346 ns, so the horizontal scanning time count is 31778 ns/12.346 ns=2574.

A display device determines image resolution according to the H_Total_{‘}Time_Count and V_Total_Time_Coun. As shown in FIGS. 1A and 1B, with different resolution data entries, the count different between one horizontal scanning time count and one vertical scanning time count is few, even to zero, resulting in incorrect resolution judgment when clock skew occurs. Therefore, embodiments of the invention classify resolution data entries with few count difference into a counting group. The resolution data entries described above are thus classified into a plurality of counting groups, comprising seven counting groups (first counting groups) according to the horizontal scanning times, as shown in FIG. 1A, and, comprising five counting groups (second counting groups) according to the vertical scanning times, as shown in FIG. 1B.

Values of horizontal and vertical scanning time counts are exclusive respectively, which resolution data entries stored in a first counting group are stored in different second counting groups. Two resolution data entries of 640×480@72 and 800×600@60, for example, are classified into the firs counting group 6 according to the horizontal scanning time counts, and are classified into second counting groups 3 and 4 respectively according to the horizontal scanning time counts.

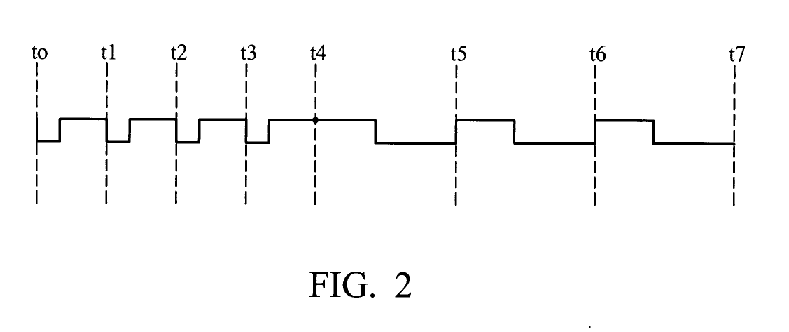

Further, the resolution data entries have different polarities respectively, simply resulting in incorrect resolution judgment while resolution variation. FIG. 2 is a schematic diagram of waveform according to the resolution data entries with different polarities according to an embodiment of the invention. Suppose the image resolution 640×480 generates waveform from time t0 to t4 and image resolution 800×600 generates waveform from time t4 to t7, in which the image resolution varied at time t4. There is unobvious signal variation for resolution determination, such that the resolution variation is just detected at time t5, causing the last waveform from time t3 to t4 by the image resolution 640×480 and the first one from time t4 to t5 by the image resolution 800×600 are invalid.

Accordingly, embodiments of the invention utilize an counter for calculating a traveling time of waveform of a clock period. Theoretically, for example, traveling times of waveform of each clock period at a fixed image resolution are identical. As shown in FIG. 2, the time counts down to time t4 while the image resolution remains with the signal value down to zero for generating waveform of a next clock period. The image resolution, however, varies at time t4, the polarity of waveform of the next clock period is opposite to the one of the waveform of the current clock period. Thus, the counter detects the last waveform of the current image resolution and the first one of the next image resolution are terminated and generated at time t4 respectively.

Each resolution data entry has a corresponding polarity in accordance with the VESA standards. Embodiments of the invention enable a display device to display accurate image resolution according to polarities using a time counter.

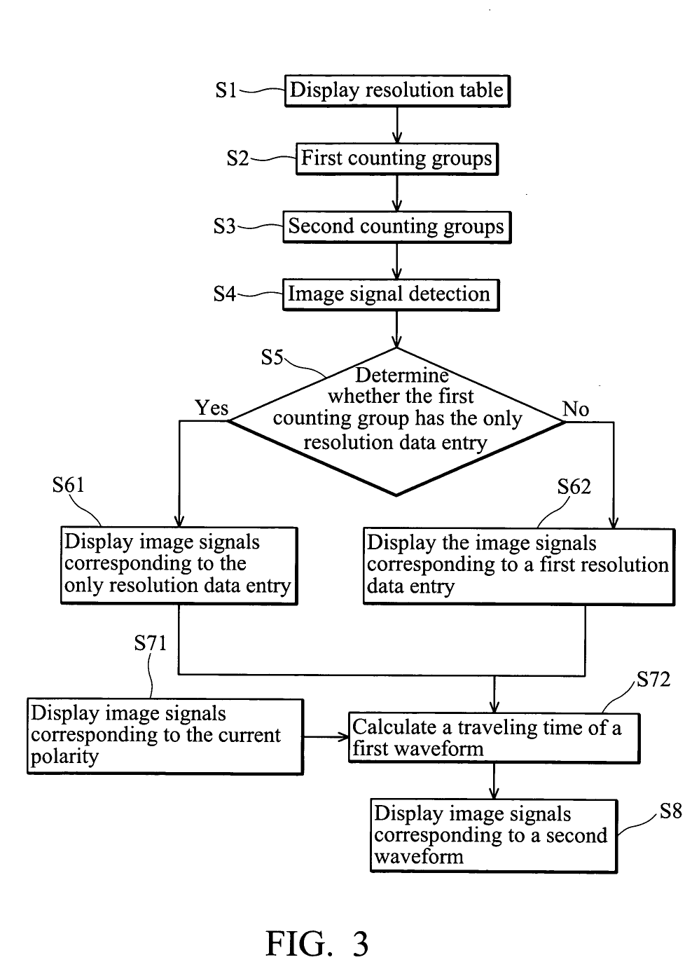

FIG. 3 is a flowchart of the method for resolution detection of an embodiment of the invention. First, a display resolution table comprising a plurality of resolution data entries corresponding to a display device is established, each resolution data entry corresponding to a first timing count and a second timing count respectively (step S1). The resolution data entries are classified into a plurality of first counting groups according to each first timing count, each first counting group comprising at least one resolution data entry and one first timing count and one second timing count corresponding to the resolution data entry (step S2).

Next, the resolution data entries are classified into a plurality of second counting groups according to each second timing count, each second counting group comprising at least one resolution data entry and one first timing count and one second timing count corresponding to the resolution data entry (step S3). The resolution data entries stored in a first counting group are stored in different second counting groups respectively. Next, image signals from a video source are detected, acquiring a first counting group and a second counting group respectively corresponding to the image signals according to the resolution data entries stored in the display resolution table (step S4).

It is determined whether the first counting group of the detected image signals has the only resolution data entry (step S5), and, if so, the process goes to step S61, and, if not, to step S62. When the only resolution data entry corresponding to the image signals is included in the first counting group, the image signals corresponding to the resolution data entry are displayed (step S61). When a first resolution data entry and at least one second resolution data entry are included in the first counting group and only the first resolution data entry is included in the second counting group, displaying the image signals corresponding to the first resolution data entry (step S62).

Next, a time counter and a polarity corresponding to the current resolution data entry are defined, and image signals corresponding to the polarity are displayed (step S71). The time counter calculates a traveling time of a first waveform corresponding to the current resolution data entry (step S72). When the traveling time is equivalent to a life cycle of the first waveform and the first waveform is changed to a second waveform corresponding to another resolution data entry, the image signals corresponding to the second waveform according to a polarities thereof are displayed (step S8).

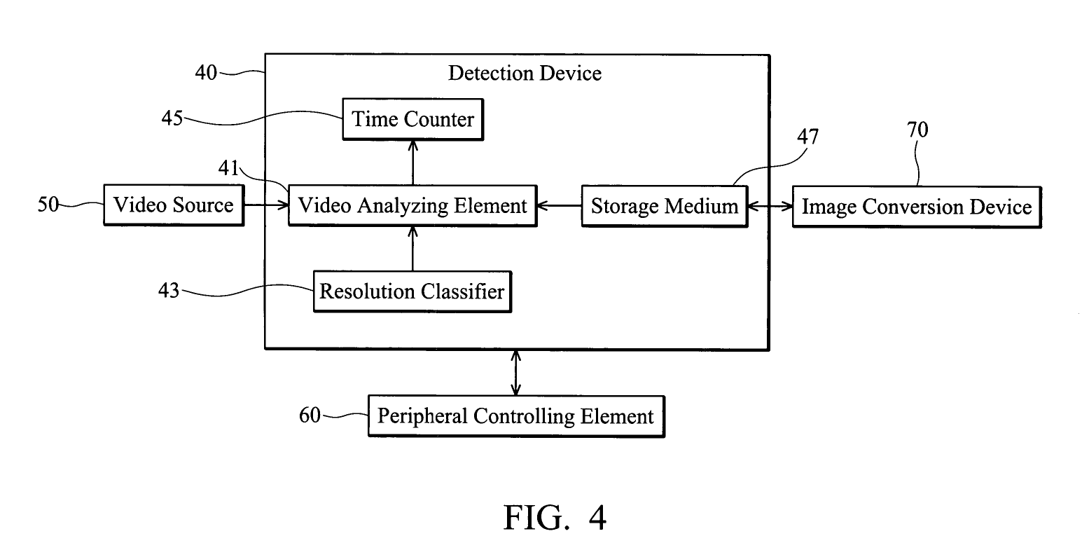

FIG. 4 is a schematic diagram of the architecture of the device for resolution detection of an embodiment of the invention. A detection device 40 comprises a video analysis unit 41, a resolution classifying device 43, a time counter 45, and a storage medium 47.

Detection device 40 receives image signals from a video source 50. Storage medium 47 stores a display resolution table corresponding to a display device, in which the table comprises a plurality of resolution data entries and polarities corresponding to the resolution data entries.

Resolution classifying device 43 classifies the resolution data entries into a plurality of first counting groups according to each first timing count, each first counting group comprising at least one resolution data entry and one first timing count and one second timing count corresponding to the resolution data entry. Further, resolution classifying device 43 classifies the resolution data entries into a plurality of second counting groups according to each second timing count, each second counting group comprising at least one resolution data entry and one first timing count and one second timing count corresponding to the resolution data entry. The resolution data entries stored in a first counting group are stored in different second counting groups respectively.

Video analysis unit 41 further comprises a video detection unit (not shown), obtaining the image signals from video source 50, acquiring a first counting group and a second counting group respectively corresponding to the image signals according to the resolution data entries stored in -the display resolution table. Video analysis unit 41 then determines whether the first counting group of the detected image signals has the only resolution data entry. When the only resolution data entry corresponding to the image signals is included in the first counting group, the image signals corresponding to the resolution data entry are displayed. When a first resolution data entry and at least one second resolution data entry are included in the first counting group and only the first resolution data entry is included in the second counting group, displaying the image signals corresponding to the first resolution data entry..

Further, time counter 45 calculates a traveling time of a first waveform corresponding to the current resolution data entry. When the traveling time is equivalent to a life cycle of the first waveform and the first waveform is changed to a second waveform corresponding to another resolution data entry, the image signals corresponding to the second waveform according to a polarities thereof are displayed.

The device further comprises a peripheral control unit 60, applying corresponding operations according to the image signals and sending control signals corresponding to the operations to remote computer devices.

The device further comprises an image conversion device 70 for image encoding, enabling rapid data transmission to remote computer devices.

Embodiments of the invention classify resolution data entries of a display device into a plurality of counting groups for accurate resolution detection, in which -the resolution data entries stored in a first counting group are stored in different second counting groups respectively. In addition, embodiments of the invention calculates the time difference while resolution variation according to polarities corresponding to resolution data entries of a display device for rapid resolution detection.

While embodiments of the invention have been described by way of example and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for detecting resolution, comprising the steps of:
establishing a display resolution table, including a plurality of resolution data entries corresponding to a display device, wherein each resolution data entry corresponds to a first timing count and a second timing count;
classifying the resolution data entries into a plurality of first counting groups according to the first timing count, wherein each first counting group comprises at least one resolution data entry and the first timing count and the second timing count corresponding to the resolution data entry;
classifying the resolution data entries into a plurality of second counting groups according to the second timing count, wherein each of the second counting group comprises at least one resolution data entry and the first timing count and the second timing count corresponding to the resolution data entry, and the resolution data entries stored in a first counting group are stored in different second counting groups respectively;
detecting image signals from a video source, acquiring a first counting group and a second counting group respectively corresponding to the image signals according to the resolution data entries stored in the display resolution table; and
displaying the image signals corresponding to a resolution data entry existing in the first and second counting groups simultaneously.

2. The method as claimed in claim 1, wherein the step of displaying the image signals corresponding to the first counting group and the second counting group further comprises the steps of:
when the only resolution data entry corresponding to the image signals is included in the first counting group, displaying the image signals corresponding to the only resolution data entry; and
when a first resolution data entry and at least one second resolution data entry are included in the first counting group and only the first resolution data entry is included in the second counting group, displaying the image signals corresponding to the first resolution data entry.

3. The method as claimed in claim 1, wherein the first timing count is obtained according to either of the horizontal and the vertical scanning times corresponding to the image signals, and the second timing count is obtained according to the other.

4. The method as claimed in claim 1, wherein each resolution data entry further comprises both the display resolution data and a vertical scanning frequency of the display device.

5. The method as claimed in claim 1, wherein two first timing counts are classified into one counting group to organize the resolution data entries when the value difference therebetween is within a threshold value.

6. A method for detecting resolution, comprising the steps of:
establishing a display resolution table, including a plurality of resolution data entries corresponding to a display device, wherein each resolution data entry corresponds to a first timing count and a second timing count;
classifying the resolution data entries into a plurality of first counting groups according to the first timing count, wherein each first counting group comprises at least one resolution data entry and one first timing count and one second timing count corresponding to the resolution data entry;
classifying the resolution data entries into a plurality of second counting groups according to the second timing count, wherein each second counting group comprises at least one resolution data entry and one first timing count and one second timing count corresponding to the resolution data entry, and the resolution data entries stored in a first counting group are stored in different second counting groups respectively;
detecting image signals from a video source, acquiring a first counting group and a second counting group respectively corresponding to the image signals according to the resolution data entries stored in the display resolution table;
displaying the image signals corresponding to a resolution data entry existing in the first and second counting groups simultaneously; and
identifying polarities corresponding to the resolution data entries for waveform change.

7. The method as claimed in claim 6, wherein the step of displaying the image signals further comprises the steps of:
when the only resolution data entry corresponding to the image signals is included in the first counting group, displaying the image signals corresponding to the only resolution data entry; and
when a first resolution data entry and at least one second resolution data entry are included in the first counting group and only the first resolution data entry is included in the second counting group, displaying the image signals corresponding to the first resolution data entry.

8. The method as claimed in claim 6, after the step of identifying the polarities, further comprising the steps of:
calculating a traveling time of first waveform corresponding to a first resolution data entry of the image signals by using a time counter; and
when the traveling time is equivalent to a life cycle of the first waveform and the first waveform is changed to the second waveform corresponding to a second resolution data entry, displaying the image signals corresponding to the second waveform according to a polarity thereof.

9. The method as claimed in claim 6, wherein the first timing count is obtained according to one of horizontal and vertical scanning times corresponding to the image signals, and the second timing count is obtained according to the other.

10. The method as claimed in claim 6, wherein the resolution data entry further comprises display resolution data and a vertical scanning frequency of the display device.

11. The method as claimed in claim 6, wherein two first timing counts are classified into one counting group when the value difference therebetween is within a threshold value.

12. A device for detecting resolution to detect image resolution of a display device, comprising:
a storage medium for storing a display resolution table including a plurality of resolution data entries and polarities corresponding to the resolution data entries;
a resolution classifying device coupled to the storage medium for classifying the resolution data entries into a plurality of first counting groups according to a first timing count, wherein each first counting group comprises at least one resolution data entry and one first timing count and the second timing count corresponding to the resolution data entry, and classifying the resolution data entries into a plurality of second counting groups according to each second timing count, wherein each second counting group comprises at least one resolution data entry and one first timing count and one second timing count corresponding to the resolution data entry, and the resolution data entries stored in a first counting group are stored in different second counting groups respectively; and
a video analysis unit, coupled to the storage medium and the resolution classifying device for analyzing image signals from a video source obtained by a video detection unit and acquiring the image resolution of the display device according to the first and the second counting groups, wherein when the only resolution data entry corresponding to the image signals is included in the first counting group, displaying the image signals corresponding to the resolution data entry, otherwise, when a first resolution data entry and at least one second resolution data entry are included in the first counting group and only the first resolution data entry is included in the second counting group, displaying the image signals corresponding to the first resolution data entry.

13. The device as claimed in claim 12, wherein the first timing count is obtained according to either of the horizontal and the vertical scanning times corresponding to the image signals, and the second timing count is obtained according to the other.

14. The device as claimed in claim 12, wherein each resolution data entry further comprises display resolution data and a vertical scanning frequency of the display device.

15. The device as claimed in claim 12, wherein two first timing counts are classified into one counting group to organize the resolution data entries when the value difference therebetween is within a threshold value.

16. The device as claimed in claim 12 further comprising a time counter coupled to the video analysis unit for calculating a traveling time of a first waveform corresponding to a first resolution data entry of the image signals, when the traveling time is equivalent to a life cycle of the first waveform and the first waveform is changed to a second waveform corresponding to a second resolution data entry, displaying the image signals corresponding to the second waveform according to a polarities thereof.

17. The device as claimed in claim 12 further comprising a peripheral control unit for applying corresponding operations according to the image signals and sending control signals corresponding to the operations to remote computer devices.

18. The device as claimed in claim 12 further comprising an image conversion device for image encoding.
